(19) United States
(12) Patent Application Publication
(10) Pub. No.: US 2026/0110779 A1
(43) Pub. Date: Apr. 23, 2026

(54) DYNAMIC FOCUSING FOR THREE-DIMENSIONAL SENSING

(71) Applicant: Lumentum Operations LLC, San Jose, CA (US)

(72) Inventors: Alan HNATIW, Ottawa (CA); Daniel John WAHL, Ottawa (CA)

(21) Appl. No.: 18/999,975

(22) Filed: Dec. 23, 2024

Related U.S. Application Data
(60) Provisional application No. 63/708,355, filed on Oct. 17, 2024.

(51) Int. Cl. G01S 7/481

(52) U.S. Cl. CPC G01S 7/4817

(57) ABSTRACT

In some implementations, an optical system includes an optical transmitter configured to transmit an optical beam toward a target, a first controller element to control a direction of the optical beam in accordance with a scanning pattern; and a focusing element configured to adjust a focal point of the optical beam in accordance with the scanning pattern.

### CROSS-REFERENCE TO RELATED APPLICATION

This Patent Application claims priority to U.S. Provisional Patent Application No. 63/708,355, filed on Oct. 17, 2024, and entitled “DYNAMIC FOCUSING FOR SENSORS.” The disclosure of the prior Application is considered part of and is incorporated by reference into this Patent Application.

### TECHNICAL FIELD

The present disclosure relates generally to a focusing element and to dynamic focusing for three-dimensional sensing.

### BACKGROUND

A focal range of an optical system may include a focal point at which light, of a beam, converges. When a target is positioned within the focal range of the optical system, the optical system may illuminate the target with the beam and may measure a reflection of the beam to perform a measurement of the target. When the target is positioned outside the focal range of the optical system, the optical system may fail to measure the reflection of the beam or may measure the reflection of the beam with less than a threshold level of accuracy. Optical systems that illuminate a target with a beam directed toward a configured focal range may be used for optical sensing (e.g., optical metrology), gesture-recognition, autonomous vehicle control, manufacturing, or medical sciences, among other examples.

### SUMMARY

In some implementations, an optical system includes an optical transmitter configured to transmit an optical beam toward a target, a first controller element to control a direction of the optical beam in accordance with a scanning pattern; and a focusing element configured to adjust a focal point of the optical beam in accordance with the scanning pattern.

In some implementations, an optical device includes at least one optical element to receive a beam with a first beam direction and output the beam with a second beam direction and a focal point; and at least one controller element to adjust the at least one optical element to change the focal point along a scanning pattern associated with the beam, wherein a focal range of the beam is adjustable such that the focal point remains in a configured plane along the scanning pattern associated with the beam.

In some implementations, a method includes identifying, by a controller, a position in a scanning pattern; adjusting, by the controller, an optical element to control a focal plane of a beam based on the position in the scanning pattern; and measuring, by the controller and using the beam, a target based on adjusting the optical element to control the focal plane of the beam.

### BRIEF DESCRIPTION OF THE DRAWINGS

FIG. 1 is a diagram of an example optical system associated with dynamic focusing for three-dimensional sensing.

FIGS. 2A-2B are diagrams of an example implementation associated with dynamic focusing for three-dimensional sensing.

FIGS. 3A-3B are diagrams of example implementations/320/340 associated with scanning patterns for three-dimensional sensing.

FIG. 4 is a flowchart of an example process associated with dynamic focusing for three-dimensional sensing.

### DETAILED DESCRIPTION

The following detailed description of example implementations refers to the accompanying drawings. The same reference numbers in different drawings may identify the same or similar elements.

An optical system may be used for an optical measurement or an optical communication. For example, an optical measurement system may transmit a beam toward a target and measure a reflection of the beam to determine a characteristic of the target. In manufacturing use cases, an optical measurement system may be used to measure a manufactured object for, for example, quality control. For example, by comparing a three-dimensional measurement of a manufactured object to a reference three-dimensional model of the manufactured object, a quality control system may determine whether the manufactured object passes a quality control test. Additionally, or alternatively, an optical measurement system may be used to determine another characteristic of a manufactured object, such as an orientation of the manufactured object, which may be used to control a pick-and-place machine or another type of computer-controlled manufacturing device.

An optical system, such as an optical measurement system, may include a transmitter that transmits an optical beam and a receiver that receives a reflection of the optical beam (e.g., reflected from a target). To perform a scan of a surface of the target, the optical system may include a scanning element that directs the optical beam to different configured positions. At each position, the optical system may transmit and measure a beam, thereby generating a “point” representation of the target at each position. The optical system may combine many points, such as hundreds, thousands, or millions of points into a point-cloud representation of the target, thereby generating a three-dimensional representation of the target (or a surface of the target).

The optical system may use one or more fixed focus optics, which results in a fixed working distance. In other words, the optical system creates a measurement volume (e.g., a range of distances) in which the target (or a surface of the target) is to be positioned. When the scanning element steers a beam from the optical system to a particular position, the beam may be directed with a curved focal plane. The curved focal plane may be associated with a curved focal range in which the optical system can obtain a measurement of a reflected beam with at least a threshold degree of accuracy. However, when the curved focal range is configured, such that a center of a target is within the curved focal range, edges of the target may be outside the curved focal range. This may result in a failure to capture measurements of the edges of the target or may result in measurements of the edges of the target failing to achieve at least a threshold degree of accuracy, which may prevent the use of or reduce the performance of automated quality control processes or computer-controlled manufacturing processes.

Some implementations described herein provide three-dimensional scanning with a flat focal plane. For example, some implementations described herein provide an optical system with a dynamic focusing element that adjusts a focus of a beam as the beam is steered to different positions along a scanning pattern. By adjusting the focus of the beam at different positions along the scanning pattern, the optical system ensures that a target (or a surface of a target) remains within a focal range of the beam. In this way, the optical system improves an accuracy or resolution of optical measurement or optical scanning. Additionally, or alternatively, the optical system may adjust a focus of a beam in connection with a three-dimensional representation or estimation of a surface of a target. For example, when a target is associated with a relatively large variation in depth, the target may have portions that are outside a focal range of a fixed flat focal plane. In this case, the optical system may adjust the focus of the beam to ensure that the target remains within the focal range of the flat focal plane when a depth of the surface of the target varies. This may enable scanning of a greater variety of targets (e.g., larger objects, deeper holes within objects, or more complex objects at various size scales), such as for manufacturing quality control or computer-controlled manufacturing, for three-dimensional scanning, for gesture recognition, or for medical operations, among other examples.

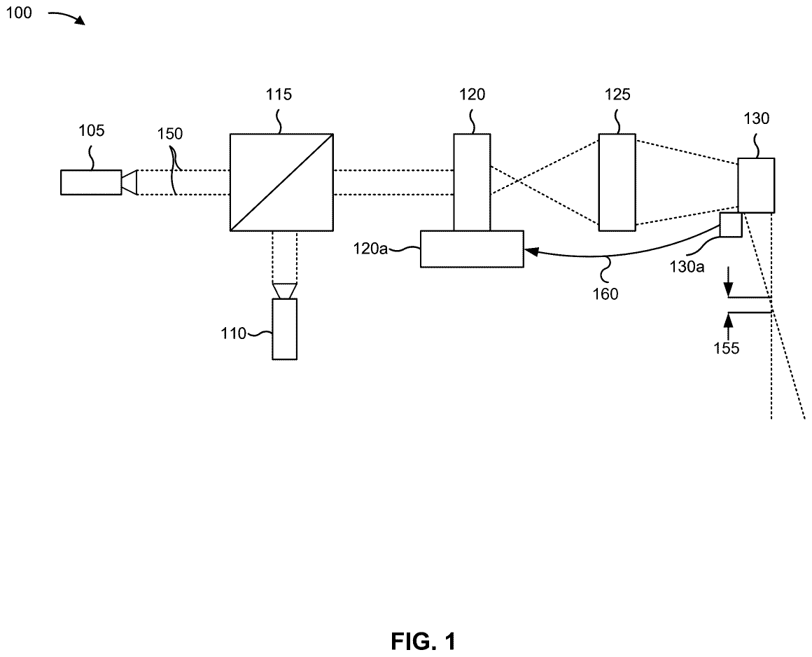

FIG. 1 is a diagram of an example optical system 100 associated with dynamic focusing for three-dimensional sensing. As shown in FIG. 1, the optical system 100 includes an optical path with an optical emitter 105, an optical receiver 110, an optical combiner/splitter 115, a focusing element 120, an optical element 125, and an optical scanner 130. The focusing element 120 may be associated with a first controller 120a. The optical scanner 130 may be associated with a second controller 130a. Although some implementations are described herein in terms of multiple controllers corresponding to multiple optical components, a single controller may control multiple optical components.

In some implementations, the optical emitter 105 may transmit one or more optical beams 150. For example, the optical emitter 105 may transmit an optical beam toward a target. In some implementations, the optical emitter 105 may include a vertical cavity surface emitting laser (VCSEL), such as a top-emitting VCSEL or a bottom-emitting VCSEL. Additionally, or alternatively, the optical emitter 105 may include an edge-emitting laser (EEL), a distributed-feedback (DFB) laser, a laser diode, a light emitting diode (LED), or another type of emitter (e.g., an emitter that is usable for time-of-flight (TOF) measurements, such as an emitter that is capable of frequency modulation, amplitude modulation, or pulse transmission). In some implementations, the optical emitter 105 may include a set of emitters configured to emit a set of beams (e.g., forming an array of spots that are directed toward a target or being multiplexed into a single, composite beam). In some implementations, the optical emitter 105 may transmit the one or more optical beams 150 toward the focusing element 120 via the optical combiner/splitter 115. The optical combiner/splitter 115 may selectively reflect a portion of a beam, such that the optical beam 150 is passed through toward the focusing element 120 and a reflection of the optical beam 150 (e.g., from a target, as described herein) is reflected toward the receiver 110.

In some implementations, the receiver 110 may include one or more photodiodes. For example, the receiver 110 may include a photodiode that is configured to perform a measurement on a reflection of the optical beam 150 (e.g., from a target). In this case, the measurement may include a time-of-flight (TOF) measurement (e.g., for determining a distance between the optical system 100 and a target). Additionally, or alternatively, the measurement may include another measurement of a characteristic of the reflection of the optical beam 150, such as a phase measurement, a frequency measurement, or an intensity measurement. In this case, the optical system 100 may derive information regarding one or more characteristics of a target at a point to which the optical beam 150 is directed, such as a depth measurement, a surface material measurement, a surface texture measurement, a surface reflectivity measurement, a Doppler measurement, or another type of measurement.

In some implementations, the focusing element 120 may be disposed in an optical path (e.g., between the optical emitter 105 and a target) to dynamically set a focal range 155 of the optical beam 150 for the optical system 100. The focal range 155 may include a depth from the optical system 100 at which light of the optical beam 150 converges (e.g., to at least a threshold degree of convergence), as shown. In some implementations, the focusing element 120 may dynamically set the focal range 155 by adjusting a focal plane of the optical beam 150 based on an instruction, signal, or command from the controller 120a. For example, as shown by reference number 160, the controller 120a may receive, from the controller 130a, an instruction, signal, or command indicating a position of the optical beam 150 along a scanning pattern, as described in more detail herein. In this case, based on the position of the optical beam 150 along the scanning pattern, the controller 120a may cause the focusing element 120 to set the focal plane, such that the focal plane remains along a flat plane. In other words, when the optical beam 150 is directed to a center of a scanning pattern, a distance between the optical system 100 and the flat plane may be at a minimum, Rₘᵢₙ, whereas, in contrast, when the optical beam 150 is directed to an edge of the scanning pattern, the distance between the optical system 100 and the flat plane may be at a maximum, Rₘₐₓ. Accordingly, the focusing element may adjust a focus of the optical beam 150, such that a first focus setting results in the focal plane being at approximately Rₘᵢₙ when the optical beam 150 is directed to the center of the scanning pattern and such that a second focus setting results in the focal plane being at approximately Rₘₐₓ when the optical beam 150 is directed to the edge of the scanning pattern. In this example, the center of the scanning pattern is at a minimum distance from the optical system 100; however, the minimum distance to the optical system 100 may occur at another portion of the scanning pattern.

Additionally, or alternatively, the focusing element 120 may set the focal plane based on a representation of a target. For example, the controller 120a may receive or store information identifying a three-dimensional representation of a target (or a surface thereof), such as a computer-aided design (CAD) file. In this case, the controller 120a may cause the focusing element 120 to adjust the focal plane, at different points along a scanning pattern, based on a predicted surface depth of the target. In other words, the focusing element 120 maintains the focal plane at a predicted surface of the target as a depth of the predicted surface of the target varies in accordance with the three-dimensional representation of the target. Additionally, or alternatively, the focusing element 120 may set the focal plane based on a measurement. For example, when the optical system 100 measures an area of the target as being at a particular depth, the focusing element 120 may adjust the focal plane, such that points within a threshold proximity to the area of the target have a focal plane at approximately the particular depth. In this case, the optical system 100 may use a particular algorithm for predicting a focal plane depth to which to set the focusing element 120, such as a fixed setting (e.g., using a prior measured depth for a next point), a predictive setting (e.g., using a group of prior measured depths to predict a next depth for a next point), or a machine learning or artificial intelligence setting, among other examples.

In some implementations, the focusing element 120 may include a type of configurable or adjustable optical element. For example, the focusing element 120 may include a movable curved mirror or a movable lens. In this case, the controller 120a may include a control element and a movable stage (e.g., onto which the focusing element 120 is mounted), such that the control element causes a movement of the movable stage, thereby adjusting a focal range of the optical beam 150. Additionally, or alternatively, the focusing element 120 may include a deformable mirror. In this case, the controller 120a may include a control element and a deformation element (e.g., that is connected to the focusing element 120 to deform the deformable mirror). Additionally, or alternatively, the focusing element 120 may include a variable focus length lens, a liquid lens, a microelectromechanical system (MEMS) element, a grating, or a diffractive optical element (DOE), among other examples.

The focusing element 120 may direct the optical beam 150 toward the optical element 125 and toward the optical scanner 130. In some implementations, the optical element 125 may include one or more optical components associated with adjusting a characteristic of the optical beam 150. For example, the optical element 125 may include an objective lens, a grating, a DOE, a filter, a mirror, or another type of optical component (e.g., another type of fixed optical component). The optical element 125 may direct the optical beam 150 toward the optical scanner 130. In some implementations, the optical scanner 130 may include one or more optical components associated with steering the optical beam 150. For example, the optical scanner 130 may include a lens, a mirror, a MEMS element, a grating, or a DOE, among other examples. In this case, the optical scanner 130 may, based on a control command, signal, or instruction from the controller 130a, cause the optical beam 150 to be directed along a scanning pattern. The scanning pattern may include a set of discrete points (or a continuous path) that the optical beam 150 covers to obtain a set of measurements of a target (e.g., at the set of discrete points or on the continuous path).

In some implementations, the optical system 100 is configured to obtain multiple concurrent measurements. For example, the optical system 100 may transmit an optical beam 150 with multiple component signals included therein and may perform measurements of the multiple component signals to determine a characteristic of a target. In other words, the optical system 100 may modulate one or more different signals with one or more different frequencies onto a common optical beam 150 and may measure changes to the one or more different signals to determine a characteristic of the target. As an example, the optical signal 100 may modulate a relatively low frequency signal to determine a relatively coarse range to the target, and one or more relatively high frequency signals to determine a relatively fine range to the target. In this case, by combining the relatively coarse range and the relative fine range, the optical system 100 may determine a range to the target (at a particular point) with a relatively high degree of accuracy. Additionally, or alternatively, the optical system 100 may generate multiple spots, which the optical scanner 130 may direct to multiple points on a target. For example, the optical emitter 105 may transmit multiple optical beams 150 concurrently, which may be directed to multiple different points on the target.

As indicated above, FIG. 1 is provided as an example. Other examples may differ from what is described with regard to FIG. 1.

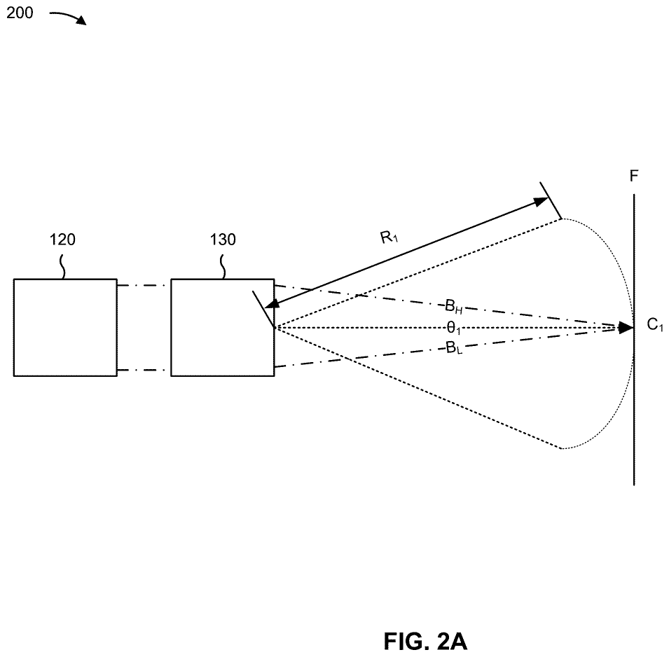

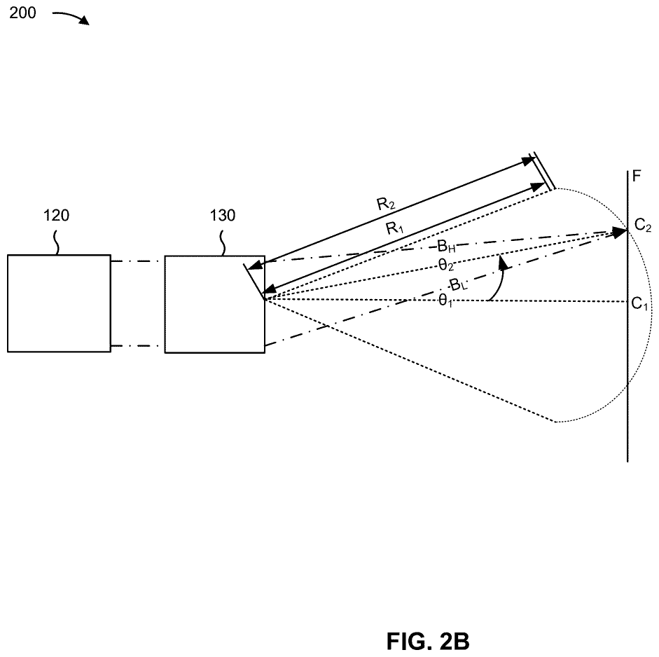

FIGS. 2A-2B are diagrams of an example implementation 200 associated with dynamic focusing for three-dimensional sensing. As shown in FIGS. 2A-2B, example implementation 200 includes a focusing element 120 and an optical scanner 130. As shown in FIG. 2A, the optical scanner 130 may direct a beam to a first position at a first angle θ₁. Light, from the beam, such as a first beam part B_{H} and a second beam part B_{L}, may converge at a point C₁ along the focal plane F, which is at a range R₁ from the optical scanner 130. As shown in FIG. 2B, the optical scanner 130 may direct the beam to a second position at a second angle θ₂. Light, from the beam, converges at a second point C₂ along the focal plane F. In this case, C₂ and the focal plane F are at a range R₂ from the optical scanner 130. To cause the light (e.g., beam parts B_{H} and B_{L}) to converge at the focal plane F, the focusing element 120 changes focusing settings from a first focusing setting at θ₁ and C₁ to a second focusing setting at θ₂ and C₂.

As indicated above, FIGS. 2A-2B are provided as an example. Other examples may differ from what is described with regard to FIGS. 2A-2B.

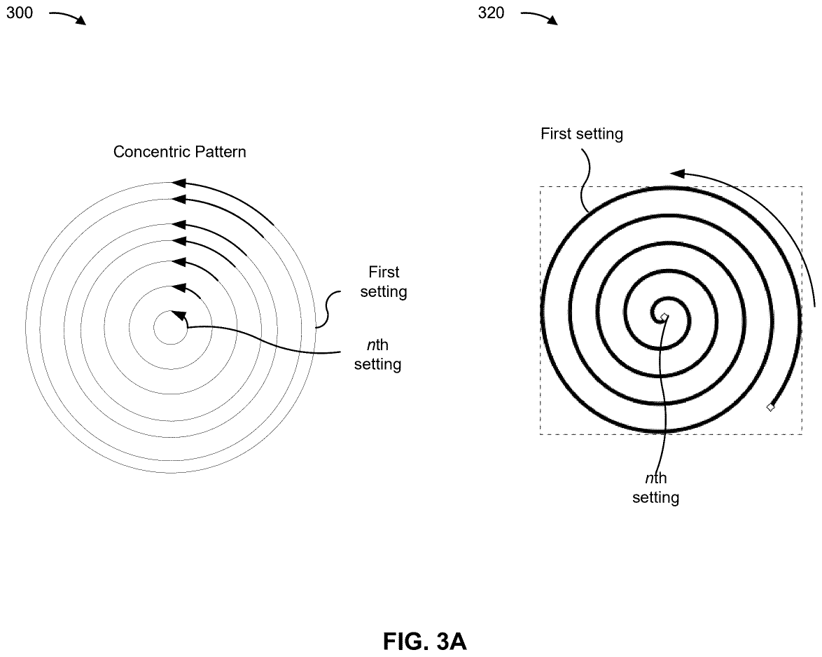

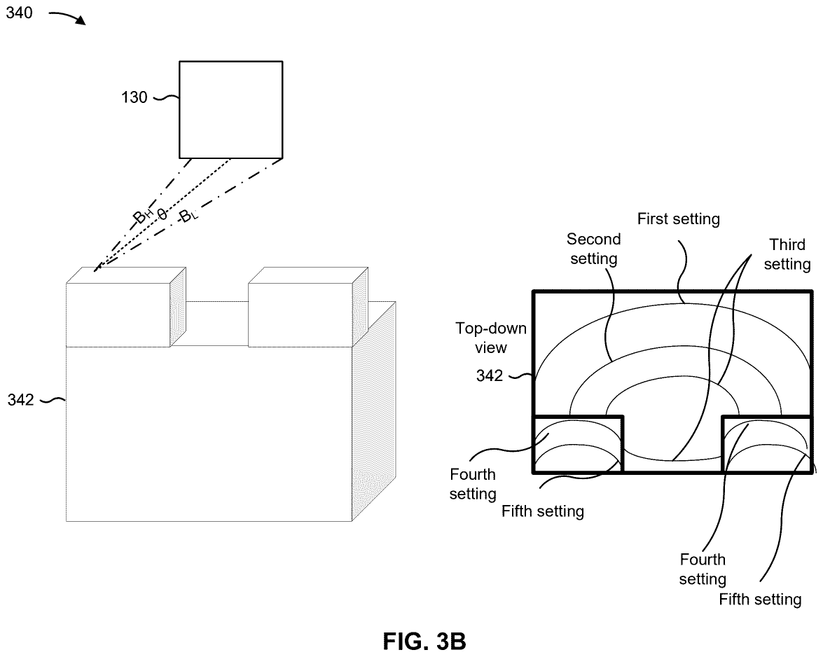

FIGS. 3A-3B are diagrams of example implementations 300/320/340 associated with scanning patterns for three-dimensional sensing. As shown in FIG. 3A and by example 300, a first scanning pattern may include an optical scanner (e.g., the optical scanner 130) performing a set of concentric circular pattern scans. In this case, when the optical scanner is aligned with a center of the concentric pattern, the optical scanner may cause a focusing element (e.g., the focusing element 120) to have a first setting for a first concentric level for a first circular scan, a second setting for a second concentric level for a second circular scan, and an nth setting for an nth concentric level for an nth circular scan, as shown. In this case, each circular scan is associated with a different setting of the focusing element to ensure convergence of an optical beam at the concentric circle. Because each point on the circle is equidistant from the optical scanner, the focusing element does not need to change focusing settings until a circular scan is complete, thereby reducing a quantity of setting changes relative to using, for example, a rectilinear scanning pattern.

As shown in FIG. 3A, and by example 320, a second scanning pattern may include an optical scanner performing a spiral pattern scan. In this case, the optical scanner may cause the focusing element to have a first setting at an outer portion of the spiral scan and an nth setting at an inner portion of the spiral scan. The focusing element may change settings via a continuous setting change (e.g., by moving a movable lens continuously as the spiral scan continues). Additionally, or alternatively, the focusing element may change settings via multiple discrete setting changes (e.g., by moving a movable lens via discrete steps as the spiral scan continues). In the discrete setting change case, the spiral scan may be a set of discrete concentric circular portions corresponding to setting change steps. Additionally, as a focal range may have a threshold range with which a target remains close enough to a focal depth to capture a measurement with a threshold accuracy, the discrete setting changes may correspond to steps that move the focal range to maintain the target within the focal range as the spiral scan is performed continuously.

As shown in FIG. 3B, and by example 340, a third scanning pattern may be performed in connection with a three-dimensional representation of a target 342 (e.g., a stored representation or a predicted representation). For example, the optical scanner 130 may scan the target 342 with different focusing settings corresponding to different areas of the target 342. In other words, in a first area of the target 342, a scanning procedure is performed with a first setting, a second setting, and a third setting (e.g., via a set of concentric circular scans). Further, in a second and third area of the target 342, which are at a different depth away from the optical scanner 130, the scanning procedure is performed with a fourth setting and a fifth setting. In this example, rather than a single flat plane for scanning, an optical system may scan multiple flat planes corresponding to multiple surfaces of the target 342 (e.g., a first flat plane for the first area and a second flat plane for the second and third areas). To control the amplitude and/or frequency of setting changes, the optical scanner 130 may follow a path of more gradual settings changes (e.g., smaller discrete or continuous settings changes) or a path of fewer settings changes (e.g., fewer discrete settings changes or a reduced speed of continuous settings changes) than may be used for another type of raster or another type of scanning pattern. In other words, the optical scanner 130 completes all scanning of a single plane or with a single setting (e.g., the single setting may, in some cases, correspond to multiple different planes depending on a geometry of the target 342) before switching to a different plane or a different setting. For example, as shown, a scan of the first area of the target 342 using the third setting may include a discontinuity (e.g., that the optical scanner 130 skips) corresponding to the second and third area of the target 342. The optical scanner 130 may return to a scan of the discontinuity after a switch to the fourth setting, as shown.

As indicated above, FIGS. 3A-3B are provided as an example. Other examples may differ from what is described with regard to FIGS. 3A-3B.

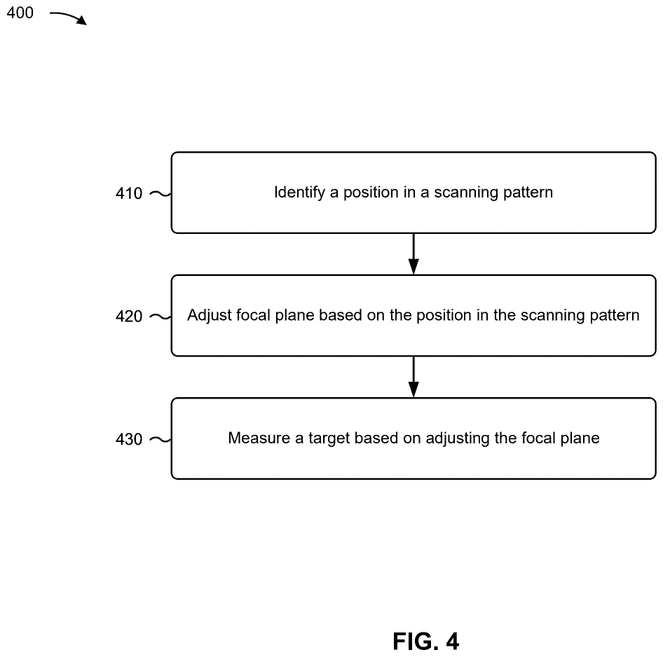

FIG. 4 is a flowchart of an example process 400 associated with dynamic focusing for three-dimensional sensing. In some implementations, one or more process blocks of FIG. 4 are performed by a controller (e.g., controller 120a or controller 130a, among other examples). In some implementations, one or more process blocks of FIG. 4 are performed by another device or a group of devices separate from or including the controller. Additionally, or alternatively, one or more process blocks of FIG. 4 may be performed by one or more components of a controller, such as a processor, a memory, an input component, an output component, and/or a communication component.

As shown in FIG. 4, process 400 may include identifying a position in a scanning pattern (block 410). For example, the controller may identify a position in a scanning pattern, as described above. In some implementations, the controller may identify the position in the scanning pattern based on a timing of a scanning or an indication of a setting of an optical scanner. In some implementations, the controller may identify the position in the scanning pattern based on a control signal or feedback signal from another controller or another feedback element of an optical system. In some implementations, the controller may predict a position in the scanning pattern (e.g., a next position) based on a digital representation of a target being scanned.

As further shown in FIG. 4, process 400 may include adjusting a focal plane based on a position in the scanning pattern (block 420). For example, the controller may adjust an optical element to control a focal plane of a beam based on the position in the scanning pattern, as described above. In some implementations, the controller may cause a deformable optical lens or mirror to be deformed, a movable optical lens or mirror to be moved, a liquid lens to be configured to a particular state, a grating to be repositioned to a particular orientation, or a MEMS system to be set to a particular setting, among other examples.

As further shown in FIG. 4, process 400 may include measuring a target based on adjusting the focal plane (block 430). For example, the controller may measure, using the beam, a target based on adjusting the optical element to control the focal plane of the beam, as described above. In some implementations, the controller may cause a beam to be transmitted to the target via the optical element and may cause a receiver to receive and measure a reflection of the beam from the target. The controller may perform a calculation based on the measurement of the reflection of the beam, such as a TOF calculation, a range calculation, a material calculation, or another type of calculation.

Process 400 may include additional implementations, such as any single implementation or any combination of implementations described below and/or in connection with one or more other processes described elsewhere herein.

In a first implementation, process 400 includes adjusting a scanning element to control a direction of the beam based on the position in the scanning pattern.

In a second implementation, alone or in combination with the first implementation, adjusting the optical element comprises setting the optical element to a discrete setting that corresponds to a position within a continuous scanning pattern.

In a third implementation, alone or in combination with one or more of the first and second implementations, process 400 includes determining a previous measurement of the target, and adjusting the optical element comprises adjusting the optical element based on the previous measurement of the target.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a controller or one or more controllers) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
an optical transmitter configured to transmit an optical beam toward a target,
a first controller element to control a direction of the optical beam in accordance with a scanning pattern; and
a focusing element configured to adjust a focal point of the optical beam in accordance with the scanning pattern.

2. The optical system of claim 1, further comprising:
an optical receiver configured to receive a reflection of the optical beam from the target.

3. The optical system of claim 1, wherein the focusing element is disposed in an optical path between the optical transmitter and the target.

4. The optical system of claim 1, wherein the focusing element includes an optical element.

5. The optical system of claim 4, wherein the optical element includes at least one of a movable curved mirror, a movable lens, a deformable mirror, a variable focus length lens, a liquid lens, a microelectromechanical system (MEMS) element, a grating, or a diffractive optical element.

6. The optical system of claim 1, wherein the focusing element includes a second controller element.

7. The optical system of claim 1, wherein the focusing element is controllable based on a digital representation of the target.

8. The optical system of claim 1, wherein the focusing element is configured to adjust the focal point of the optical beam such that a focal range corresponds to the target across the scanning pattern.

9. The optical system of claim 1, wherein the scanning pattern is formatted to achieve a configured amplitude or frequency or combination thereof of focal point changes during a scanning procedure.

10. An optical device, comprising:
at least one optical element to receive a beam with a first beam direction and output the beam with a second beam direction and a focal point; and
at least one controller element to adjust the at least one optical element to change the focal point along a scanning pattern associated with the beam,
wherein a focal range of the beam is adjustable such that the focal point remains in a configured plane along the scanning pattern associated with the beam.

11. The optical device of claim 10, further comprising:
a scanning element to direct the beam along the scanning pattern; and
a feedback element to provide a control signal from the scanning element to the at least one controller element, such that a change to a beam direction in connection with the scanning pattern corresponds to a change to the focal range.

12. The optical device of claim 11, wherein the scanning element is configured to direct the beam along a spiral pattern.

13. The optical device of claim 11, wherein the scanning element is configured to direct the beam along one or more concentric levels.

14. The optical device of claim 10, wherein the at least one controller element is configured to control the at least one optical element based on a stored three-dimensional representation of a target for scanning.

15. The optical device of claim 10, wherein the configured plane is a flat plane.

16. The optical device of claim 10, wherein the configured plane is a plurality of flat planes corresponding to a three-dimensional representation of a target for scanning.

17. A method, comprising:
identifying, by a controller, a position in a scanning pattern;
adjusting, by the controller, an optical element to control a focal plane of a beam based on the position in the scanning pattern; and
measuring, by the controller and using the beam, a target based on adjusting the optical element to control the focal plane of the beam.

18. The method of claim 17, further comprising:
adjusting a scanning element to control a direction of the beam based on the position in the scanning pattern.

19. The method of claim 17, wherein adjusting the optical element comprises:
setting the optical element to a discrete setting that corresponds to a position within a continuous scanning pattern.

20. The method of claim 17, further comprising:
determining a previous measurement of the target; and
wherein adjusting the optical element comprises:
adjusting the optical element based on the previous measurement of the target.
